(19) United States
(12) Patent Application Publication
(10) Pub. No.: US 2014/0373331 A1
(43) Pub. Date: Dec. 25, 2014

(54) METHOD OF PROTECTING A LENS OF A LIGHT

(71) Applicants: Jeff Ahlskog, Edmonton (CA); Chris Ahlskog, Edmonton (CA)

(72) Inventors: Jeff Ahlskog, Edmonton (CA); Chris Ahlskog, Edmonton (CA)

(21) Appl. No.: 14/191,804

(22) Filed: Feb. 27, 2014

Related U.S. Application Data
(60) Provisional application No. 61/837,551, filed on Jun. 20, 2013.

(51) Int. Cl. F21V 17/04

(52) U.S. Cl. CPC F21V 17/04
USPC 29/428

(57) ABSTRACT

A method of protecting a lens of a light having a rear facing surface and a front face with a light display area, the front face having a shape defined by edges between the rear facing surface and the front face, the edges including at least a first edge, a second edge, and a pair of parallel edges between the first edge and the second edge, the method comprising: positioning a transparent portion of a cover over the light display area; and latching hooks, extended from the cover, around the first edge, the second edge, and the pair of parallel edges, to the rear facing surface to secure the cover to the front face.

### CROSS-REFERENCE TO RELATED APPLICATIONS

This application claims the benefit under 35 USC 119(e) of U.S. provisional application Ser. No. 61/837,551 filed Jun. 20, 2013.

### TECHNICAL FIELD

This document relates to methods of protecting a lens of a light.

### BACKGROUND

Floodlights at work sites may have wire cages screwed onto the light for protecting the floodlight during operation. For transport the wire cage allows flying debris to enter through the mesh thereby breaking the glass lens of the fixture. Thus, such light fixtures are removed before transport and reinstalled upon arrival at the new location.

### SUMMARY

A method of protecting a lens of a light having a rear facing surface and a front face with a light display area, the front face having a shape defined by edges between the rear facing surface and the front face, the edges including at least a first edge, a second edge, and a pair of parallel edges between the first edge and the second edge, the method comprising: positioning a transparent portion of a cover over the light display area; and latching hooks, extended from the cover, around the first edge, the second edge, and the pair of parallel edges, to the rear facing surface to secure the cover to the front face.

A method comprising: installing covers over lights, such as floodlights, on an oil rig, the covers being at least partially, and in some cases fully, transparent and each having hooks distributed about a perimeter of the cover, each hook being shaped to latch to a rear facing surface of a respective light to collectively secure the cover in place; and transporting the oil rig with the covers installed.

A method of protecting a lens of a light having a rear facing surface and a front face with a light display area, the front face having a shape defined by edges, the method comprising: sliding a transparent portion of a cover across the light display area; and latching hooks, extended from the cover, around the edges, to the rear facing surface to secure the cover to the front face.

In various embodiments, there may be included any one or more of the following features: The hooks comprise a pair of rails, and positioning further comprises: mounting each rail of the pair of rails around a respective edge of the pair of parallel edges; and sliding the rails along the pair of parallel edges to position the cover over the front face. The hooks comprise a leading hook and a trailing hook extended from a leading edge and a trailing edge of the cover, respectively, in which latching further comprises latching the leading hook around the first edge and the trailing hook around the second edge. The front face has a rectangular shape, such as a square shape, and the cover is shaped to correspond with the front face. The first edge and the second edge are longer than the pair of parallel edges. The cover comprises a dampening cushion to limit vibration transfer between the fixture and the cover. The cover is secured to the front face without fasteners. One or more of the hooks comprise: a reinforcement tab extended from the cover; a spacer at a base, and on an inside facing surface, of the reinforcement tab; and a hook portion mounted to the spacer. The light is a floodlight installed on an oil rig. The oil rig is transported with the cover installed on the light. The cover comprises polycarbonate, plexiglass, or other clear plastics. The hooks comprise a pair of rails, the edges comprise a pair of parallel edges, and sliding further comprises: mounting each rail of the pair of rails around a respective edge of the pair of parallel edges; and sliding the rails along the pair of parallel edges to position the cover over the front face.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a bottom perspective view of a protective cover for a light.

FIG. 2 is a perspective view of the cover of FIG. 1 being slid over the front face of a floodlight.

FIG. 3 is a perspective view of FIG. 2 illustrating the cover in an installed and secured position.

FIG. 4 is a section view taken along the 4-4 section lines of FIG. 3 and illustrating of one of the hooks latched over the light of FIG. 3.

FIG. 5 is a method of transporting an oil rig light with a cover installed.

### DETAILED DESCRIPTION

Immaterial modifications may be made to the embodiments described here without departing from what is covered by the claims.

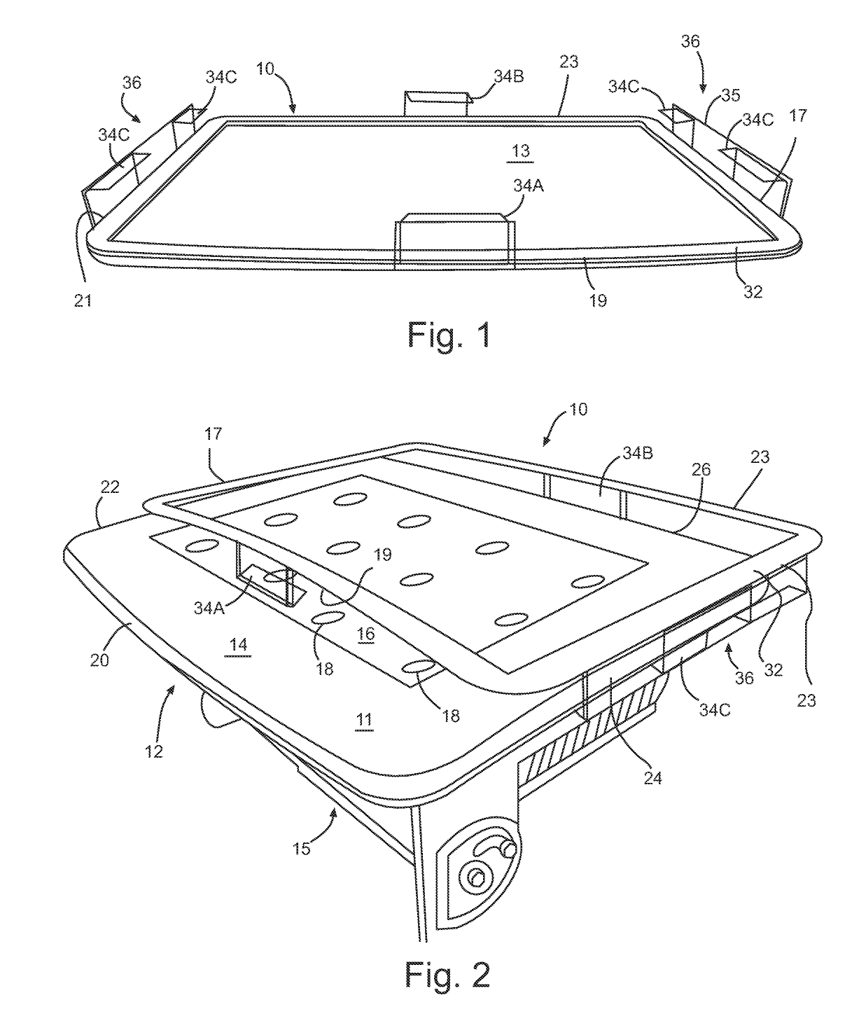

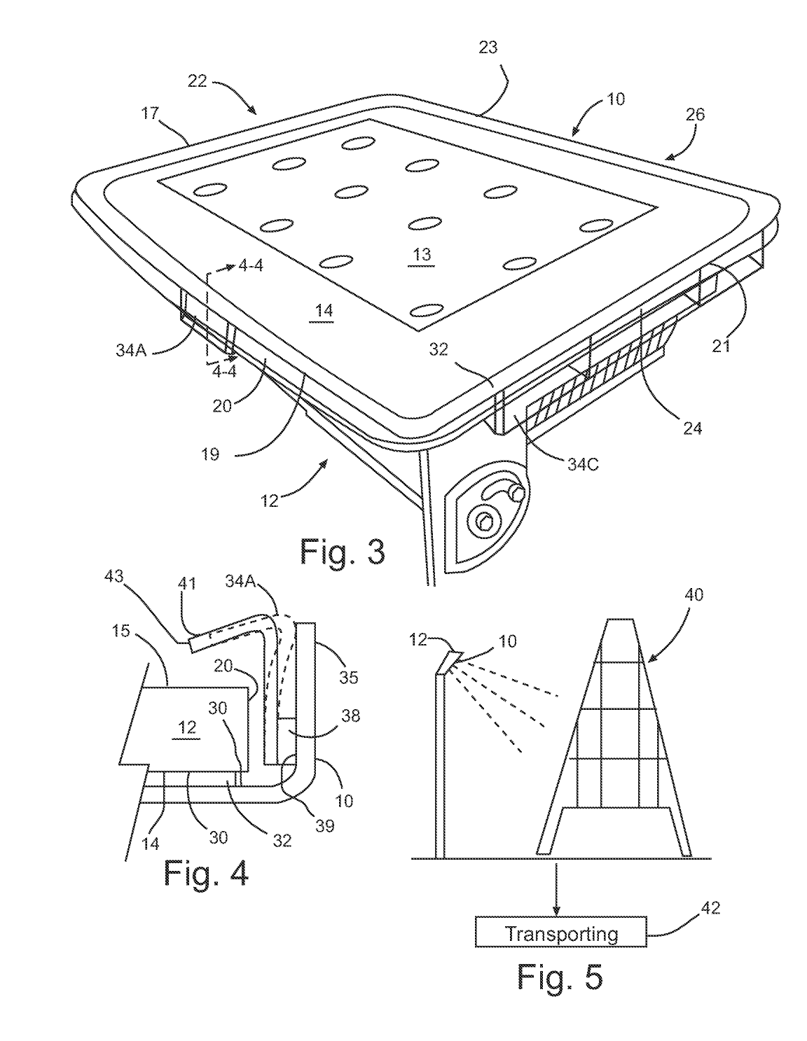

Referring to FIGS. 1-4, a method of protecting a lens 16 of a light 12 with a cover 10 is illustrated. Light 12 has one or more rear facing surfaces 15 (FIG. 4), a front face 14, and edges, such as at least a first edge 20, a second edge 26, and a pair of parallel edges 22 and 24 between the first edge 20 and the second edge 26 (FIGS. 2-3). The edges 20, 22, 24, and 26 are between the rear facing surface 15 and the front face 14.

The front face 14 may have a light display area or lens 16 (FIG. 2), a flanged border area 11, and an overall shape defined by edges 20, 22, 24, and 26 (FIGS. 2-3). Area 16 may include one or more lights, such as light emitting diode (LED) lights. The light 12 illustrated is a high voltage (120-380V) floodlight made by Cooper US, Inc. of Houston, Tex. The style of light illustrated also has a flanged front face 14 whose back side defines the rear facing surface 15.

Cover 10, for example made of LEXAN™ polycarbonate has a transparent portion 13, which may span between cover edges 17, 19, 21, and 23. As shown in FIG. 3, the front face 14 may have a rectangular shape, and the cover 10 may be shaped to correspond with the front face 14. Thus, when in the secured position (FIG. 3), transparent portion 13 may cover the light display area 16, while cover edges 17, 19, 21, and 23 may overlay light edges 22, 20, 24, and 26, respectively.

Cover 10 may have hooks 34 extended, for example perpendicularly, from the cover 10 (FIG. 1). Exemplary hooks include hooks 34A, 34B, and 34C. In the secured position (FIG. 3), hooks 34A, 34B, and 34C may be latched around the first edge 20, the second edge 26, and the pair of parallel edges 22 and 24, respectively, to the rear facing surface 15. The latching of hooks 34 serves to secure the cover 10 to the front face 14.

Hooks 34C may function as a pair of rails 36 (FIGS. 2-3). Thus, positioning of the cover 10 over the front face 14 may proceed as follows. First, as shown in FIG. 2, each rail 36 of the pair of rails 36 may be mounted around a respective one of the pair of parallel edges 24 and 22. Edges 22 and 24 are on opposed sides of light 12 because edges 22 and 24 are parallel. To facilitate mounting, hook 34A and leading cover edge 19 may be flexed upwards. Next, as shown in FIG. 3, once mounted the rails 36 may be slid along the pair of parallel edges 22, 24 to position the cover 10 over the front face 14. Such is also one example of sliding portion 13 across the light display area. As cover 10 is nearing the secured position shown in FIG. 3, trailing hook 34B (FIG. 2) latches around edge 26 to under surface 15. Similarly, referring to FIGS. 3 and 4, as cover 10 moves into the secured position shown hook 34 a latches around edge 20 to surface 15.

Referring to FIG. 4, one or more of the hooks 34 may comprise a reinforcement tab 35 extended, for example perpendicularly and integrally, from the cover 10. A spacer 38 may be mounted at a base, and on an inside facing surface 39, of the reinforcement tab 35. A hook portion 41 may be mounted to the spacer 38. Such a configuration permits hook portion 41 to move through a range of flex (illustrated in dashed lines) until it reaches reinforcement tab 35, after which flex is restricted. Flex permits the hook 34A to open under force exertion to latch or de-latch the cover 10, while reinforcement strengthens the hook system and reduces the possibility of cover 10 falling off of light 12 once secured. A tip 43 of hook portion 41 may be directed, for example angled, towards a light facing surface 30 of cover 10.

Referring to FIGS. 2 and 3, in some cases the first edge 20 and the second edge 26 are longer than the pair of parallel edges 22 and 24, for example if front face 14 has a shape that is rectangular but non square as shown. Square shapes may be used in other cases. Mounting of rails 36 on the short edges 17 and 21 instead of the long edges 19 and 23 means that any flexing that may occur during mounting and sliding (FIG. 2) occurs mainly on the long edge 19, which is easier to flex than would be a shorter edge 21 made of same material.

Referring to FIGS. 1-4, the cover 10 may comprise a dampening cushion 32 that at least partially surrounds the light display area 16 when the cover 10 is secured (FIGS. 3 and 4). The cushion 32, such as a neoprene insert, may serve to prevent ingress of debris or fluids to light display area 16, as well as to reduce and dissipate vibration.

As shown in FIGS. 3 and 4, when installed cover 10 may be secured to light 12 without fasteners such as screws, bolts, adhesives, or other components. Instead, a tight fit between cover 10 and light 12, along with the natural resiliency of the cover 10 material and hooks 34 may be all that is used to secure the cover 10 to light 12. Installation without fasteners may require relatively fewer parts, tools, and effort to accomplish.

Referring to FIG. 5, in some cases the cover 10 may be any suitable cover having hooks 34 distributed about a perimeter of the cover 10, and the light 12 may be a floodlight installed on an oil rig 40. In another stage 42, at least a portion or the entirety of the oil rig may be transported with the cover 10 still installed on the light 12. Currently, light fixtures must be removed before transportation may occur. Removal and re-installation of the light fixtures may take two to three additional days, so leaving the covers 10 on decreases rig up time and lowers overhead costs. Lights 12 may be installed on drilling rigs, and servicing rigs.

Parallel edges 22 and 24 may be straight enough and parallel enough to allow the hooks 34 to slide as rails along the edges 22 and 24. Thus, nominal deviations from straightness and parallelness are encompassed. Non oil-rig applications may be used for lights 12, for example in gymnasiums, football fields, hazardous industrial locations, work camps, residential and commercial areas, temporary infrastructure, light towers, stadiums, and any application where there is a risk of lens damage due to debris. Light 12 may be powered by a generator (not shown). Each of parallel edges 24 may be respectively formed by a portion of an edge. The front face 14 may have a non-rectangular or non-polygonal shape, such as an oval or circular shape.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A method of protecting a lens of a light having a rear facing surface and a front face with a light display area, the front face having a shape defined by edges between the rear facing surface and the front face, the edges including at least a first edge, a second edge, and a pair of parallel edges between the first edge and the second edge, the method comprising:
positioning a transparent portion of a cover over the light display area; and
latching hooks, extended from the cover, around the first edge, the second edge, and the pair of parallel edges, to the rear facing surface to secure the cover to the front face.

2. The method of claim 1 in which the hooks comprise a pair of rails, and positioning further comprises:
mounting each rail of the pair of rails around a respective edge of the pair of parallel edges; and
sliding the rails along the pair of parallel edges to position the cover over the front face.

3. The method of claim 2 in which the hooks comprise a leading hook and a trailing hook extended from a leading edge and a trailing edge of the cover, respectively, in which latching further comprises latching the leading hook around the first edge and the trailing hook around the second edge.

4. The method of claim 2 in which the front face has a rectangular shape, and the cover is shaped to correspond with the front face.

5. The method of claim 4 in which the first edge and the second edge are longer than the pair of parallel edges.

6. The method of claim 1 in which the cover comprises a dampening cushion to limit vibration transfer between the light and the cover.

7. The method of claim 1 in which the cover is secured to the front face without fasteners.

8. The method of claim 1 in which one or more of the hooks comprise:
a reinforcement tab extended from the cover;
a spacer at a base, and on an inside facing surface, of the reinforcement tab; and
a hook portion mounted to the spacer.

9. The method of claim 1 in which the light is a floodlight installed on an oil rig.

10. The method of claim 9 further comprising transporting the oil rig with the cover installed on the light.

11. The method of claim 1 in which the cover comprises polycarbonate.

12. A method comprising:
installing covers over lights on an oil rig, the covers being at least partially transparent and each having hooks distributed about a perimeter of the cover, each hook being shaped to latch to a rear facing surface of a respective light to collectively secure the cover in place; and
transporting the oil rig with the covers installed.

13. A method of protecting a lens of a light having a rear facing surface and a front face with a light display area, the front face having a shape defined by edges, the method comprising:
sliding a transparent portion of a cover across the light display area; and
latching hooks, extended from the cover, around the edges, to the rear facing surface to secure the cover to the front face.

14. The method of claim 13 in which the hooks comprise a pair of rails, the edges comprise a pair of parallel edges, and sliding further comprises:
mounting each rail of the pair of rails around a respective edge of the pair of parallel edges; and
sliding the rails along the pair of parallel edges to position the cover over the front face.

15. The method of claim 1, wherein:
the hooks comprise a pair of rails, a leading hook and a trailing hook extended from a leading edge and a trailing edge of the cover, respectively, in which latching further comprises latching the leading hook around the first edge and the trailing hook around the second edge;
the positioning further comprises:
mounting each rail of the pair of rails around a respective edge of the pair of parallel edges, and
sliding the rails along the pair of parallel edges to position the cover over the front face; and
the front face has a rectangular shape, and the cover is shaped to correspond with the front face.

16. The method of claim 15 in which the first edge and the second edge are longer than the pair of parallel edges.

17. The method of claim 1 in which the hooks comprise a pair of rails, in which the cover comprises a dampening cushion to limit vibration transfer between the light and the cover, and positioning further comprises:
mounting each rail of the pair of rails around a respective edge of the pair of parallel edges; and
sliding the rails along the pair of parallel edges to position the cover over the front face.

18. The method of claim 17 in which the hooks comprise a leading hook and a trailing hook extended from a leading edge and a trailing edge of the cover, respectively, in which latching further comprises latching the leading hook around the first edge and the trailing hook around the second edge,

19. The method of claim l in which the hooks comprise a pair of rails, in which the light is a floodlight installed on an oil rig, and positioning further comprises:
mounting each rail of the pair of rails around a respective edge of the pair of parallel edges; and
sliding the rails along the pair of parallel edges to position the cover over the front face.

20. The method of claim 19 in which the hooks comprise a leading hook and a trailing hook extended from a leading edge and a trailing edge of the cover, respectively, in which latching further comprises latching the leading hook around the first edge and the trailing hook around the second edge.
